(19) United States
(12) Patent Application Publication
(10) Pub. No.: US 2026/0158848 A1
(43) Pub. Date: Jun. 11, 2026

(54) VEHICLE WASTE AIR RECAPTURE SYSTEM

(71) Applicant: FCA US LLC, Auburn Hills, MI (US)

(72) Inventor: Paul H. Ams, Auburn Hills, MI (US)

(21) Appl. No.: 18/973,540

(22) Filed: Dec. 9, 2024

(51) Int. Cl. B60H 1/00

(52) U.S. Cl. CPC B60H 1/00028; B60H 1/00207; B60H 1/00564; B60H 2001/00214; B60H 2001/00607

(57) ABSTRACT

A vehicle HVAC system including a blower positioned proximate a heat exchanger and configured to blow conditioned air into a passenger cabin. A waste air duct having a first open end positioned proximate another heat exchanger is configured to receive waste air that has passed through the heat exchanger. A waste air fan is positioned at a second open end of the waste air duct, and the waste air fan is configured to be rotated by the waste air passing through the waste air duct. An output shaft connected to the waste air fan is configured to be rotated by the waste air fan. The output shaft is connected to and configured to rotate the blower such that the blower may blow the conditioned air to the passenger cabin without being powered by a vehicle battery.

### FIELD

The present disclosure relates to a vehicle having a waste air recapture system for an HVAC system.

### BACKGROUND

This section provides background information related to the present disclosure which is not necessarily prior art.

Recent years have seen rapid growth in the adoption of electric vehicles (EVs) by consumers and companies alike, with substantial research and development being directed to increasing vehicle range. One method for increasing range involves the modification of existing vehicle systems such that the demand on the vehicle battery is lowered, which permits the charge that otherwise would be used by the vehicle system to be redirected to increasing the total potential range of the vehicle.

Conventionally, vehicle air conditioning (HVAC) systems are powered by the vehicle battery, which can drain battery charge that might otherwise be contributable to the potential drivable range of the vehicle. There is a need, therefore, to develop a system that would alleviate at least a portion of a vehicle air conditioning system's reliance on the battery to enable that energy to be repurposed towards increasing the potential drivable range of the vehicle.

### SUMMARY

This section provides a general summary of the disclosure, and is not a comprehensive disclosure of its full scope or all of its features.

According to a first aspect of the present disclosure, there is provided a vehicle that may include a body defining a forward compartment and a passenger cabin; a battery; an HVAC system provided in the forward compartment and configured to provide conditioned air to the passenger cabin, the HVAC system including a compressor that is powered by the battery, a first heat exchanger in communication with the compressor, a second heat exchanger in communication with each of the first heat exchanger and the compressor, a blower positioned proximate the second heat exchanger and configured to blow the conditioned air to the passenger cabin, a waste air duct positioned having a first open end positioned proximate the first heat exchanger that is configured to receive waste air that has passed through the first heat exchanger and an opposite second open end, a waste air fan positioned at the second open end, the waste air fan being configured to be rotated by the waste air passing through the waste air duct, and an output shaft connected to the waste air fan that is configured to be rotated by the waste air fan, wherein the output shaft is connected to and configured to rotate the blower such that the blower may blow the conditioned air to the passenger cabin without being powered by the battery.

According to the first aspect, the HVAC system may also include a gearbox between the waste air fan and the output shaft, the gearbox being configured to increase a rotational speed of the output shaft in comparison to a rotational speed of the waste air fan.

According to the first aspect, the HVAC system may further include a controller; a clutch in communication with the controller and positioned between the output shaft and the gearbox; and a sensor in communication with the controller that is configured to generate a signal indicative of a velocity of the vehicle, wherein upon receipt of the signal indicative of the velocity of the vehicle, the controller is configured to engage and disengage the clutch to either permit or prevent rotation of the output shaft.

According to the first aspect, the sensor generates a signal indicative of the velocity of the vehicle being greater than a predetermined threshold, the controller is configured to engage the clutch to permit rotation of the output shaft to rotate the blower.

According to the first aspect, the waste air duct is tapered such that the waste air increases in velocity to rotate the waste air fan as the waste air travels from the first open end to the second open end.

According to the first aspect, the waste air fan includes a shaft extending in a first direction that is connected to the gearbox, the output shaft is oriented orthogonal relative to the shaft, and the gearbox enables rotation of the shaft to be translated to output shaft.

According to the first aspect, the HVAC system may further include a blower motor that rotates the blower, is powered by the battery, and is in communication with the controller, wherein if the sensor generates a signal indicative of a velocity of the vehicle being beneath the predetermined threshold, the controller disengages the clutch and operates the blower motor using power of the battery to rotate the blower.

According to a second aspect of the present disclosure, there is provided a vehicle that may include a body defining a forward compartment and a passenger cabin; a controller; a sensor in communication with the controller that is configured to generate a signal indicative of a velocity of the vehicle; a battery; an HVAC system provided in the forward compartment and configured to provide conditioned air to the passenger cabin, the HVAC system including a compressor that is powered by the battery, a first heat exchanger in communication with the compressor, a second heat exchanger in communication with each of the first heat exchanger and the compressor, a blower positioned proximate the second heat exchanger and configured to blow the conditioned air to the passenger cabin, a waste air duct positioned having a first open end positioned proximate the first heat exchanger that is configured to receive waste air that has passed through the first heat exchanger and an opposite second open end, a waste air fan positioned at the second open end that is configured to be rotated by the waste air passing through the waste air duct, and an output shaft connected to the waste air fan that is configured to be rotated by the waste air fan, wherein the output shaft is connected to and configured to selectively rotate the blower based on a signal generated by the controller when the sensor generates a signal indicative of the velocity of the vehicle being about a predetermined threshold such that the blower may blow the conditioned air to the passenger cabin without being powered by the battery.

According to the second aspect, the HVAC system may further include a gearbox between the waste air fan and the output shaft, the gearbox being configured to increase a rotational speed of the output shaft in comparison to a rotational speed of the waste air fan.

According to the second aspect, the HVAC system may further include a clutch in communication with the controller and positioned between the output shaft and the gearbox, wherein upon receipt of the signal indicative of the velocity of the vehicle, the controller is configured to engage and disengage the clutch to either permit or prevent rotation of the output shaft.

According to the second aspect, the sensor generates a signal indicative of the velocity of the vehicle being greater than a predetermined threshold, the controller is configured to engage the clutch to permit rotation of the output shaft to rotate the blower.

According to the second aspect, the waste air duct is tapered such that the waste air increases in velocity to rotate the waste air fan as the waste air travels from the first open end to the second open end.

According to the second aspect, the waste air fan includes a shaft extending in a first direction that is connected to the gearbox, the output shaft is oriented orthogonal relative to the shaft, and the gearbox enables rotation of the shaft to be translated to output shaft.

According to the second aspect, the HVAC system may further include a blower motor that rotates the blower, is powered by the battery, and is in communication with the controller, wherein if the sensor generates a signal indicative of a velocity of the vehicle being beneath the predetermined threshold, the controller disengages the clutch and operates the blower motor using power of the battery to rotate the blower.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a battery powered vehicle having a conventional HVAC system; and

FIG. 2 is a schematic illustration of a battery powered vehicle having an air recapture system according to a principle of the present disclosure; and

FIG. 3 is a schematic diagram showing a connection between the vehicle battery and various elements of the system according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

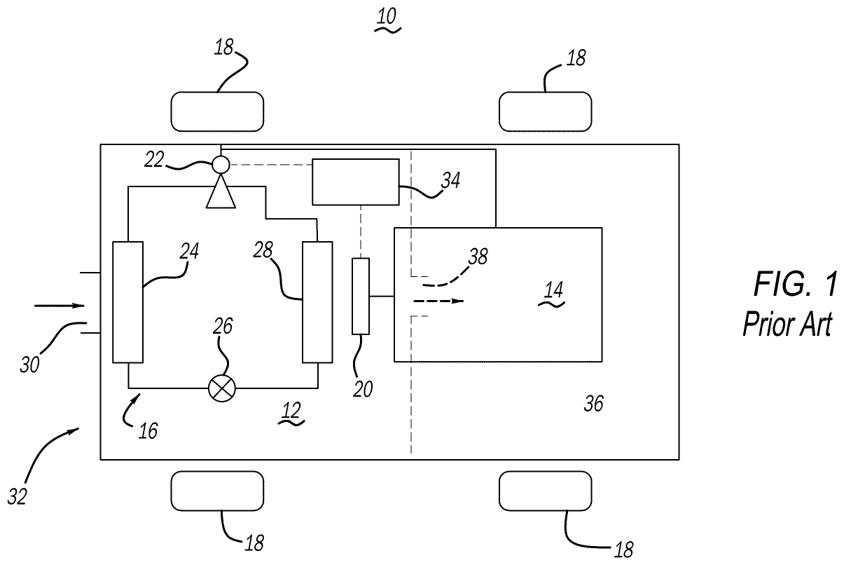

FIG. 1 schematically illustrates a vehicle 10 having a conventional HVAC system. Vehicle 10 includes a forward body compartment 12 that may house an electric propulsion system (not shown) and a heating, ventilation, and air conditioning (HVAC) system 16. Vehicle 10 also includes a battery 14. Battery 14 may be in communication with and provide power to HVAC system 16, at least one of the wheel assemblies 18 via the electric propulsion system (not shown), a blower 20, and other known vehicle systems (e.g. vehicle lighting). It should be understood that while a battery propelled vehicle is illustrated, the vehicle 10 could alternatively house an internal combustion engine (ICE) or operate as a hybrid vehicle containing both a battery and internal combustion engine, if desired.

HVAC system 16 may include at least a compressor 22, a first heat exchanger (i.e., condenser) 24, an expansion device 26 such as an expansion valve or capillary tube, and a second heat exchanger 28 (i.e., evaporator). While not shown in FIG. 1, it should be understood that HVAC system 16 may include additional components such as a dryer, accumulator, fan, and other components that are known to one skilled in the art. Conventionally, ambient air enters the HVAC system 16 from outside the vehicle 10 through an inlet 30, which may be a grille or other opening in or near the vehicle front end 32.

A controller 34 is in communication with and operable to control compressor 22 and blower 20 upon receipt of a signal from a user input inside a passenger cabin 36, or upon receipt of a signal generated by other various temperature or air condition sensors (not shown) in the vehicle 10 to operate the compressor 22 and/or blower 20 according to the received input or signal. The air is then heated and/or cooled by the HVAC system 16 according to the signal provided to controller 34 and delivered as conditioned air to the passenger cabin 36 through a vent 38 as would be understood to those skilled in the art by way of the blower 20. However, in this arrangement, at least some air that passes through the first heat exchanger 24 is uncaptured by the system 16 and exits the vehicle 10 from an underside (not shown) of the body 12 as wasted air. This is especially so when the vehicle 10 is traveling at increased or highway speeds. Additionally, both the compressor 22 and blower 20 may require power exclusively from battery 14 to operate, which decreases overall battery 14 charge, thereby decreasing the total potential range of vehicle 10.

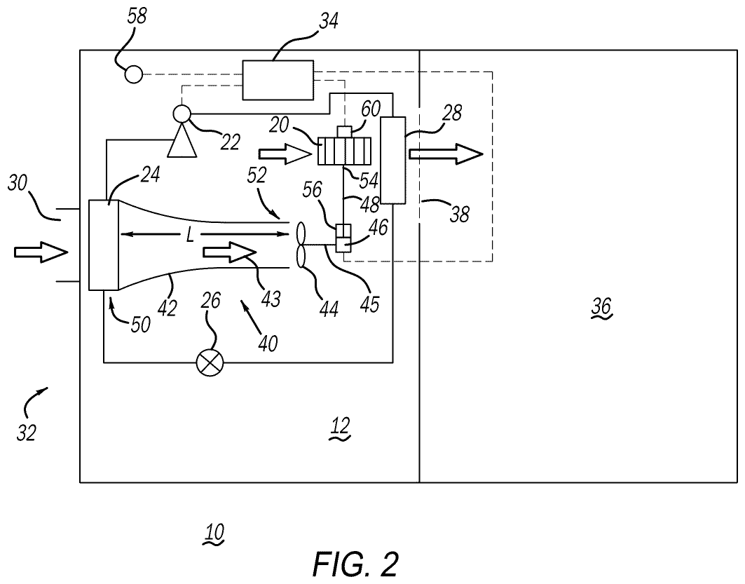

With the above in mind and now referring to FIG. 2, the present disclosure provides for an air recapture system 40 that is configured to be integrated within the HVAC system 16 of vehicle 10 in order to capture and repurpose the wasted air for use as an alternative or additional energy source for powering the blower 20. System 40 includes at least a waste air duct 42, a waste air fan 44, a step-up gear box 46, and an output shaft 48, which will now be discussed in greater detail.

Duct 42 is configured to allow the otherwise wasted air 43 that passes through the first heat exchanger 24 to be directed to waste air fan 44. Duct 42 extends from a first or primary end 50 positioned proximate the vehicle front end 32 to a second or terminal end 52 positioned proximate the passenger cabin 38. Duct 42 may be tapered as illustrated to increase a velocity of the air passing therethrough, and be situated directly rearward of or attached to the first heat exchanger 24, but may alternatively be situated rearward of the inlet 30 or other opening at the vehicle front end 32 independent of the first heat exchanger 24 location. A length L of duct 42 may vary depending on vehicle design. Duct 42 is preferably formed of a polymer such as polypropylene, but may be formed of any suitable material, and it should be understood that duct is substantially hollow along its length and open at both ends to permit air 43 to flow freely through the duct 42. Waste air fan 44 may be situated within or directly rearward of second end 52 of duct 42, with the rotational axis of fan 44 being positioned coaxial with an axis of duct 42 such that the fan 44 can be driven to rotate by the waste air 43 that passes through the duct 42. As noted above, duct 42 may be tapered to increase a velocity of the waste air 43, which can assist in driving rotation of the waste air fan 44.

Waste air fan 44 includes a shaft 45 that rotates along with waste air fan 44 and is attached to a gearbox 46. Gearbox 46 may be a step-up gearbox having a plurality of gears (not shown) that as waste air fan 44 and shaft 45 rotate, is configured to translate the rotational energy of shaft 45 to an output shaft 48 that is arranged orthogonal to shaft 45 and configured to rotate blower 20. The gears (not shown) of gearbox 46 may also increase a rotational speed of output shaft 48 to rotate a rotational shaft 54 of blower 20 at a rate that may be greater than the rotation of waste air fan 44. Rotational shaft 54 may be connected to output shaft 48 or may be a part of (i.e., unitary with) output shaft 48.

According to the above-described structure, waste air 43 passing through duct 42 can be used to drive the rotation of waste air fan 44 and shaft 45, and the rotation of these components can then be translated by gearbox 46 and utilized to rotate output shaft 48 to rotate blower 20 without having to use battery 14. In this manner, the loss of charge that would otherwise be attributed to operating the blower 20 can be avoided and the range of vehicle 10 increased. It should be noted that blower 20 may be a centrifugal-style blower, but could be any acceptable blower as would be known to those skilled in the art. It should additionally be noted that while the output shaft 48 and rotational shaft 54 of blower 20 are illustrated as being arranged orthogonal shaft 45 of waste air fan 44, the blower 20 may be arranged coaxially with shaft 45 depending on vehicle 10 design and available space.

Blower 20 may be located upstream of the second heat exchanger 28 as illustrated, but blower 20 may be located downstream of second heat exchanger 28 or in any other location that would be beneficial to providing conditioned air to the passenger cabin 36 without the expenditure of additional power from battery 14, as desired.

It should be understood that air recapture system 40 may only be in operation when vehicle 10 is travelling above a certain threshold velocity. For example, when vehicle 10 is travelling at a velocity of 30 mph or greater. Such a velocity may be required to achieve a desired velocity of the air 43 passing through duct 42 to drive rotation of waste air fan 44. The velocity of vehicle 10 can be determined by, for example, using a sensor 58 that is in communication with controller 34 and may be, for example, a sensor that determines a position of a vehicle acceleration pedal (not shown), an encoder sensor attached to one of the wheels 18, or a sensor associated with the propulsion system (not shown) that can generate a signal indicative of a load being exerted by the propulsion system.

Inasmuch as it may be desirable to only operate recapture system 40 under desirable conditions, it should be understood that a clutch 56 may be positioned between gearbox 46 and output shaft 48 such that when engaged with output shaft 48 permits output shaft 48 to rotate and when disengaged (i.e., at velocities below 30 mph) does not permit output shaft 48 to rotate. As shown in FIG. 2, clutch 56 may be in communication with controller 34 such that when controller 34 determines that vehicle 10 is travelling above the threshold velocity via a signal generated by sensor 58, a signal may be communicated by controller 34 to an actuator (not shown) of clutch 56 to engage output shaft 48.

If vehicle 10 is not travelling above the threshold velocity and clutch 56 is not engaged with output shaft 48, it may still be necessary to operate blower 20 to provide the desired level of comfort to occupants of cabin 36. Blower 20, therefore, may also include a separate motor 60 for rotating blower 20 that is in communication with controller 34.

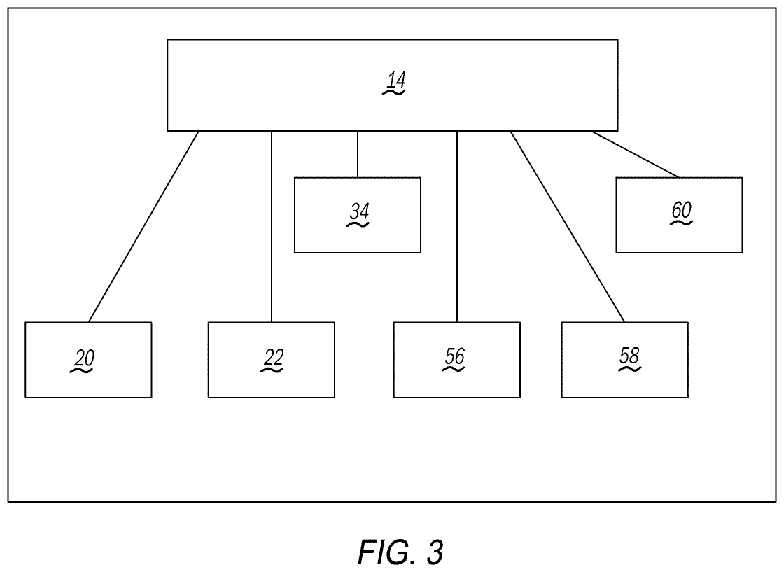

Turning now to FIG. 3, a schematic diagram illustrating the connections between battery 14 and various vehicle 10 systems and/or elements is shown. Battery 14 may be in communication with HVAC system 16 by way of compressor 22 and blower 20, controller 34, clutch 56, sensor 58, and motor 60. Air recapture system 40 alleviates battery 14 demand for at least the blower motor 60 by providing an alternative or additional energy source for powering the blower 20.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a body defining a forward compartment and a passenger cabin;
a battery;
an HVAC system provided in the forward compartment and configured to provide conditioned air to the passenger cabin, the HVAC system including:
a compressor that is powered by the battery;
a first heat exchanger in communication with the compressor;
a second heat exchanger in communication with each of the first heat exchanger and the compressor;
a blower positioned proximate the second heat exchanger and configured to blow the conditioned air to the passenger cabin;
a waste air duct positioned having a first open end positioned proximate the first heat exchanger that is configured to receive waste air that has passed through the first heat exchanger and an opposite second open end;
a waste air fan positioned at the second open end, the waste air fan being configured to be rotated by the waste air passing through the waste air duct; and
an output shaft connected to the waste air fan that is configured to be rotated by the waste air fan,
wherein the output shaft is connected to and configured to rotate the blower such that the blower may blow the conditioned air to the passenger cabin without being powered by the battery.

2. The vehicle according to claim 1, further comprising a gearbox between the waste air fan and the output shaft, the gearbox being configured to increase a rotational speed of the output shaft in comparison to a rotational speed of the waste air fan.

3. The vehicle according to claim 2, further comprising:
a controller;
a clutch in communication with the controller and positioned between the output shaft and the gearbox; and
a sensor in communication with the controller that is configured to generate a signal indicative of a velocity of the vehicle,
wherein upon receipt of the signal indicative of the velocity of the vehicle, the controller is configured to engage and disengage the clutch to either permit or prevent rotation of the output shaft.

4. The vehicle according to claim 3, wherein the sensor generates a signal indicative of the velocity of the vehicle being greater than a predetermined threshold, the controller is configured to engage the clutch to permit rotation of the output shaft to rotate the blower.

5. The vehicle according to claim 1, wherein the waste air duct is tapered such that the waste air increases in velocity to rotate the waste air fan as the waste air travels from the first open end to the second open end.

6. The vehicle according to claim 2, wherein the waste air fan includes a shaft extending in a first direction that is connected to the gearbox, the output shaft is oriented orthogonal relative to the shaft, and the gearbox enables rotation of the shaft to be translated to output shaft.

7. The vehicle according to claim 3, further comprising a blower motor that rotates the blower, is powered by the battery, and is in communication with the controller,
wherein if the sensor generates a signal indicative of a velocity of the vehicle being beneath the predetermined threshold, the controller disengages the clutch and operates the blower motor using power of the battery to rotate the blower.

8. A vehicle comprising:
a body defining a forward compartment and a passenger cabin;
a controller;
a sensor in communication with the controller that is configured to generate a signal indicative of a velocity of the vehicle;
a battery;
an HVAC system provided in the forward compartment and configured to provide conditioned air to the passenger cabin, the HVAC system including:
a compressor that is powered by the battery;
a first heat exchanger in communication with the compressor;
a second heat exchanger in communication with each of the first heat exchanger and the compressor;
a blower positioned proximate the second heat exchanger and configured to blow the conditioned air to the passenger cabin;
a waste air duct positioned having a first open end positioned proximate the first heat exchanger that is configured to receive waste air that has passed through the first heat exchanger and an opposite second open end;
a waste air fan positioned at the second open end, the waste air fan being configured to be rotated by the waste air passing through the waste air duct; and
an output shaft connected to the waste air fan that is configured to be rotated by the waste air fan,
wherein the output shaft is connected to and configured to selectively rotate the blower based on a signal generated by the controller when the sensor generates a signal indicative of the velocity of the vehicle being about a predetermined threshold such that the blower may blow the conditioned air to the passenger cabin without being powered by the battery.

9. The vehicle according to claim 8, further comprising a gearbox between the waste air fan and the output shaft, the gearbox being configured to increase a rotational speed of the output shaft in comparison to a rotational speed of the waste air fan.

10. The vehicle according to claim 9, further comprising a clutch in communication with the controller and positioned between the output shaft and the gearbox, wherein upon receipt of the signal indicative of the velocity of the vehicle, the controller is configured to engage and disengage the clutch to either permit or prevent rotation of the output shaft.

11. The vehicle according to claim 10, wherein the sensor generates a signal indicative of the velocity of the vehicle being greater than a predetermined threshold, the controller is configured to engage the clutch to permit rotation of the output shaft to rotate the blower.

12. The vehicle according to claim 8, wherein the waste air duct is tapered such that the waste air increases in velocity to rotate the waste air fan as the waste air travels from the first open end to the second open end.

13. The vehicle according to claim 9, wherein the waste air fan includes a shaft extending in a first direction that is connected to the gearbox, the output shaft is oriented orthogonal relative to the shaft, and the gearbox enables rotation of the shaft to be translated to output shaft.

14. The vehicle according to claim 10, further comprising a blower motor that rotates the blower, is powered by the battery, and is in communication with the controller,
wherein if the sensor generates a signal indicative of a velocity of the vehicle being beneath the predetermined threshold, the controller disengages the clutch and operates the blower motor using power of the battery to rotate the blower.
